(19) United States
(12) Patent Application Publication
(10) Pub. No.: US 2007/0136122 A1
(43) Pub. Date: Jun. 14, 2007

(54) Interactive billboard and contact service

(75) Inventor: Elmo Marcus Attila Diederiks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics

(21) Appl. No.: 10/578,657

(22) PCT Filed: Nov. 8, 2004
(86) PCT No.: PCT/IB04/52339

§ 371 Date: May 9, 2006

Related U.S. Application Data
(60) Provisional application No. 60/518,923, filed on Nov. 10, 2003.

(51) Int. Cl. G07G 1/00; G07G 1/14

(52) U.S. Cl. 705/10; 705/14

(57) ABSTRACT

An electronic billboard provides a “third-party” response-number for viewers to respond to a currently displayed electronic message. For the duration that a message is displayed on the electronic billboard, and optionally for a short duration afterwards, calls that are received at the response-number are routed to a contact-number of the party that posted the message. Because the contact-number to which the response-number forwards the response is not known to the sender of the response, the identity of the poster of the message remains anonymous. Because the duration that responses to the poster of the message is limited, the amount of abuse that a responder can inflict upon the poster of the message is limited.

This invention relates to the field of electronic communications, and in particular, to an electronic billboard that facilitates interaction among cell-phone users.

Electronic billboards are well known in the art, as is electronic messaging among cell-phone users. SMS (Short Messaging Service) technology allows a cell-phone user to send a relatively short text message to another SMS-compatible receiver, such as another cell-phone, an e-mailbox, an electronic billboard, and so on.

An increasing problem with SMS-messaging, however, is that once a person's SMS contact number becomes known, that person has virtually no control over the SMS messages that are sent to him/her. This is also true of the disclosure of a person's telephone number, but because SMS-messaging, like chat-room-messaging, provides a sender with a sense of protection/disguise, and because the receiver is unable to “hang-up” on the sender before the sender completes the transmission of the message, the likelihood of abuse via SMS-messaging is substantially higher than abuse by telephone calls.

If a person posts his/her SMS contact number on a billboard, the potential for abuse increases substantially, because the SMS contact number is broadcast to any potential viewer of the billboard.

However, absent the potential for abuse, an electronic billboard could be an ideal medium for facilitating interaction among the viewers of the billboard, and in particular, viewers that have access to a SMS-messaging device, such as a cell-phone. This increased interaction among cell-phone users will be of particular benefit to cell-phone service providers.

It is an object of this invention to provide an electronic billboard that facilitates interaction among SMS-enabled viewers. It is a further object of this invention to provide an electronic billboard that facilitates interaction among viewers without making the viewers vulnerable to substantial subsequent abuse. It is a further object of this invention to provide an electronic billboard that facilitates interaction among cell-phone users, to potentially increase revenues for cell-phone service providers.

These objects, and others, are achieved by an electronic billboard that provides a “third-party” response-number for viewers to respond to a currently displayed electronic message. For the duration that a message is displayed on the electronic billboard, and optionally for a short duration afterwards, calls that are received at the response-number are routed to contact-number of the party that posted the message. Because the contact-number to which the response-number forwards the response is not known to the sender of the response, the identity of the poster of the message remains anonymous. Because the duration that responses are routed to the poster of the message is limited, the amount of abuse that a responder can inflict upon the poster of the message is limited.

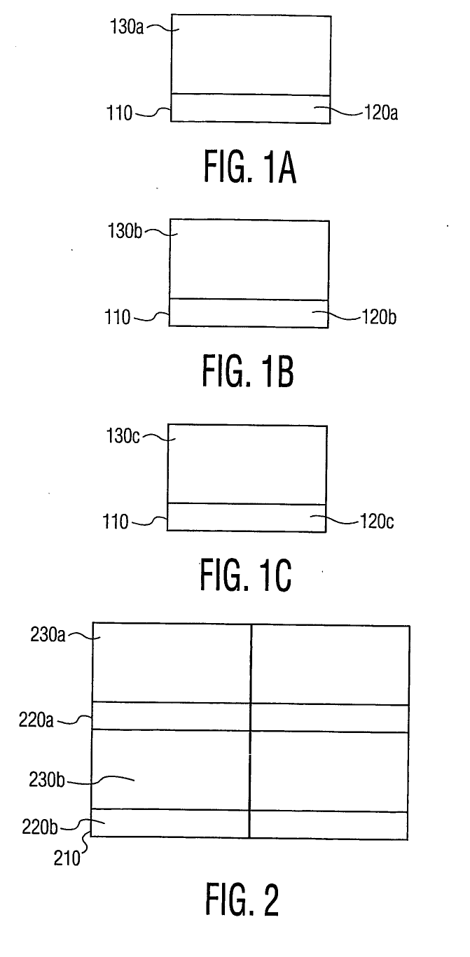

FIGS. 1A-1C illustrates an example time-series of a single-panel electronic billboard in accordance with this invention.

FIG. 2 illustrates an example illustration of a multi-panel electronic billboard in accordance with this invention.

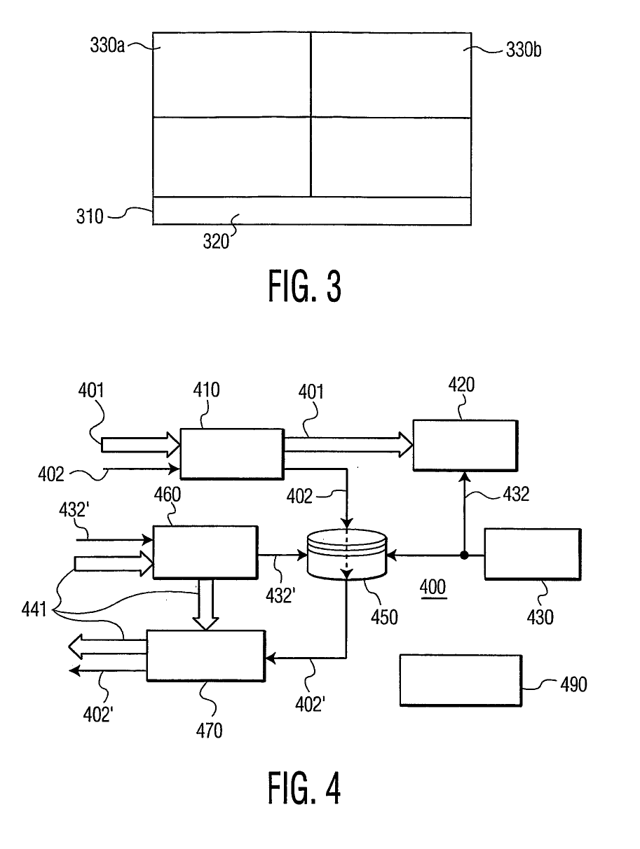

FIG. 3 illustrates an example illustration of another multi-panel electronic billboard in accordance with this invention.

FIG. 4 illustrates an example block diagram of an electronic billboard in accordance with this invention.

Throughout the drawings, the same reference numeral refers to the same element, or an element that performs substantially the same function.

For ease of reference and understanding, this invention is presented using the paradigm of cell-phone users sending SMS.(Short Messaging Service) messages in response to messages posted on an electronic bulletin board. One of ordinary skill in the art will recognize that the principles of this invention are not limited to a particular messaging format or protocol, and that other types of messages, such as a voice-mail messages, MMS (Multimedia Messaging Service) messages, and so on, can be used.

Also, the following terms are used to facilitate understanding, but are not intended to limit the spirit or scope of this invention:

“billboard-provider”: provider of the services to facilitate the posting/display of messages on a billboard. The billboard-provider may include multiple parties or a subset of parties. For example, one party may provide the billboard display, another party may provide the information that is presented to the billboard display, and yet another party may provide services for receiving responses to the messages presented on the billboard display. Conversely, the billboard-provider may be an intermediary who coordinates some or all of the activities of these parties to effect the capabilities of the billboard of this invention.

“poster”: originator of a message that is intended for posting/display on the billboard and intended recipient of responses to the posting. The poster may include multiple parties, or a subset of parties. For example, an advertising firm may provide the message, and a marketing group may receive the responses. Conversely, the poster may be an intermediary who provides, for example, the message from the advertising firm and supplies the responses to the marketing group.

“number”: terms such as response-number, contact-number, etc. are used herein for convenience, and are not intended to limit the invention to numeric values. As commonly used in the art, the term “number”, as used in such terms as “customer-number”, “account-number”, and so on, are not necessarily limited to the numerals 0-9, and may include alphabetic characters and other symbols.

FIGS. 1A-1C illustrates an example time-series of a single-panel electronic billboard 110. FIG. 1A illustrates the billboard 110 at a first time interval, displaying a message 130a; FIG. 1B illustrates the billboard 110 at a second subsequent time interval, displaying a message 130b; and FIG.; 1C illustrates the billboard 110 at a third subsequent time interval, displaying a message 130c.

With regard to FIG. 1A, in accordance with this invention, the billboard 110 includes a response-number 120a that is provided for viewers of the billboard 110 to respond to the currently displayed message, via, for example, an SMS message. Of particular note, the response-number 120a is provided by the provider of the billboard 110; the response-number 120a is not part of the message 130a. As discussed further below, the poster of the message 130a provides the billboard-provider with a contact-number to which responses to the message 130a are to be routed. When an SMS message is received at the response-number 120a, the billboard-provider routes the SMS message to the contact-number associated with the currently displayed message 130a. In this manner, because the contact-number is only known to the billboard-provider, the poster of the message 130a remains substantially anonymous. When a new message is subsequently displayed on the billboard with this same response-number, the billboard-provider routes subsequent responses to the contact-number that is associated with the new message. In this manner, because the time-duration that the response-number 120a is associated with the contact-number of the poster of the message 130a, the potential abuse to which the poster may be subjected is limited.

In an embodiment of this invention, to avoid having slightly-delayed responses being routed to the wrong contact-number, the billboard provider uses different response numbers 120a, 120b for immediately time-adjacent messages. For example, if the duration that the billboard displays each message is fifteen minutes, and a viewer notices the message 130a during the fifteenth minute of its display and commences a response, the response may not be completed and/or received by the billboard-provider until after message 130b is being displayed. If the same response-number is displayed on the billboard for both messages 130a and 130b, when this late-response to message 130a is received while message 130b is being displayed, the billboard provider will likely send the message to the contact-number associated with message 130b, rather than the contact-number associated with message 130a, particularly if it is received well after a viewer could have responded to the message 130b. If the billboard-provider alternates the use of two response-numbers in the above example, the response-number 120b will be different from the response-number 120a, and there will be a fifteen minute “buffer period”. available, during which any late-responses received at the response-number 120a could be routed to the contact-number associated with the message 130a. In a preferred embodiment, this buffer period is further segregated into a first period for receiving late-responses at the response-number 120a, and a second period for refusing acceptance of further messages at the response-number 120a, thereby providing a “clear period” between receiving responses to message 130a and enabling receiving responses to message 130c, using the same response-number at 120a, 120c. During this clear period, subsequent calls may be refused, resulting in a busy-signal to the sender, or, a recorded message could be provided, advising the responder that the contact-number is no longer valid. If the billboard-provider uses additional alternative response-numbers, the duration of the buffer period and/or clear period can be correspondingly increased. Optionally, to allow for a longer response period, the responder may be provided the option of identifying which of N previously displayed messages at this contact-number the response is to be directed. Each displayed message may have an identifying index number, or the system could read-back some or all of the displayed message to the responder for selection, using an SMS-to Speech converter. These and other techniques for managing the association of each response to the proper message will be evident to one of ordinary skill in the art in view of this disclosure.

Various alternatives are available to the above described example implement, consistent with this invention. For example, a single telephone number can be associated with the billboard, and the aforementioned response-number 120a, 120b, 120c can be an “extension-number” that the responder enters after being connected to the single telephone number. In like manner, the aforementioned response-number 120a, 120b, 120c can be a required entry in the body of the response-message, and the billboard-provider routes the response-message after extracting this response-number from the response-message. These and other alternatives will be evident to one of ordinary skill in the art in view of this disclosure, such as the example illustrations of multi-panel electronic billboards in FIGS. 2 and 3.

In FIG. 2, a multi-panel billboard 210 is presented wherein each panel of the billboard includes a response-number 220a, 220b. The operation of this example billboard is similar to the billboard of FIG. 1. A viewer responds to a particular message 230a, 230b, by using the corresponding response-number 220a, 220b. A buffer period can be provided between subsequent displays using various schemes, depending upon the process used to present the multiple panels. If each panel is updated with a new message in a sequential manner, for example, if message 230b is replaced five minutes after message 230a is replaced, and each message is displayed for twenty minutes, then the use of a single additional response-number would allow for a five buffer period between subsequent uses of the same response-number. If, on the other hand, all of the panels are updated simultaneously, four additional response-numbers would be required to provide a buffer period for each of the response-numbers, and the buffer period would be twenty minutes long.

In FIG. 3, a multi-panel billboard 310 is presented wherein a common response-number 320 is provided for all of the currently displayed messages 330a, 330b, etc. A variety of techniques can be used to facilitate the routing of response-messages to the messages 330a, 330b, etc. In a simple and straightforward embodiment, any response-message message that is received at the response-number 320 is forwarded to the contact-numbers associated with each of the currently displayed messages 330a, 330b, etc., and the recipients of these response messages (the poster of the messages 330a, 330b, etc.) can select which messages to ignore. In a more selective embodiment, the responder can be provided the option of selecting where to route the response-message, using, for example, a “press 1 for the upper-left; press 2 for the upper-right; . . . ” voice-messaging menu scheme. Alternatively, each pane may have a pre-defined, or explicitly noted, “extension number” that the responder enters after establishing a connection via the response number 320. Additionally, as noted above, an SMS-to-Speech converter can be used to read-back some or all of current or prior messages to a responder to facilitate the identification of the message to which the response-message is directed.

Depending upon the particular scheme used to present messages in a multi-panel billboard system, one of ordinary skill in the art will recognize, in view of this disclosure, that any of a variety of schemes can be used to facilitate an identification of a select panel to which a response is directed. Based on the identification of the select panel, the billboard-provider can easily route the response-message to the poster of the message in the select panel, via the contact-number provided by the poster.

FIG. 4 illustrates an example block diagram of an electronic billboard system 400 in accordance with this invention.

A posting receiver 410 receives a message 401 for posting on a billboard 420, along with a contact-number 402 for routing responses to the message 401 to the poster of the message 401. In a typical environment, the posting receiver 410 receives an SMS message 401 from a cell-phone user, and the contact-number 402 is a messaging number that routes received messages to this same cell-phone. However, this invention is not dependent upon the means used to effect the posting of a message 401 to the billboard 420, nor a correspondence between the device used to post the message 401 and a device configured to receive messages that are sent to the contact-number 402.

A controller 490 controls the operation of the billboard system 400. At some point in time, the controller 490 allocates time on the billboard 420 to the message 401. As noted above, however, the contact-number 402 is not published to the billboard 420. Instead, a response-number 432 is provided by the billboard system 400 for display on the billboard 420 when the message 401 is displayed. As noted above, the system 400 may have one or more response-numbers that it can use, and a response-number block 430 is illustrated to indicate the process of generating and/or allocating response-numbers 432 to each message 402.

Assuming that the system 400 includes more than one response-number 432, a database 450 stores the correspondence between the contact-number 402 provided by the poster of the message 401 and the response-number 432 provided by the response-number block 430.

A response receiver 460 is configured to receive a response-message 441 associated with a received-response-number 432′. Assuming that the system 400 includes more than one response-number 432, the received-response-number 432′ is provided to the database 450 to determine the contact-number 402′ corresponding to the received-response-number 432′. If the system 400 includes only one response-number 432, and the received-response-number 432′ matches this response-number 432, the contact-number 402′ is the contact-number 402 of the most recently displayed message 401.

A response transmitter 470 is configured to receive the response-message 441 from the response-receiver 460, along with the determined contact-number 402′ from the database 450, or directly from the posting receiver 410 if only one response-number 432 exists, and is configured to transmit the response-message 460 to the contact-number 402′.

As noted above, because the contact-number 402′ is known only to the provider of the system 400, nominally the provider of the billboard 420, subsequent contact with the poster of the message 401 is limited, thereby preserving the anonymity of the poster of the message 401, and minimizing the potential abuse to which the poster of the message 401 may be subject. Also, because the responder replies to the response receiver 460; and not directly to the poster of the message 401, the poster cannot use features such as “caller-ID” to identify the responder, thereby preserving the anonymity of the responder, and eliminating the potential abuse to which the responder may be subjected by the poster.

Optionally, the billboard-provider could provide another set of third-party response numbers for further isolated communications between the responder and the poster, which numbers would remain in effect until one of the parties requests a termination.

As noted above, this invention could be of particular interest to cell-phone service providers for increasing cell-phone usage, thereby potentially increasing revenues. This invention is also of particular interest to billboard-providers for potentially increasing revenues. The poster of a message to a billboard with an enabled response-number can be charged an additional fee. Similarly, each responder to the message via the response-number can be charged a fee. Additionally, the poster of the message may be charged a fee that is based upon the number of responses to the posted message. These and other methods of generating revenue will be evident to one of ordinary skill in the art in view of this disclosure.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular structural details of. the example embodiment of FIG. 4 can be changed without affecting the intent or scope of this invention. The posting receiver 410 and response receiver 460, for example, may be embodied as a single receiver, wherein the response-number, or other number, or lack thereof, determines whether the received message 401, 441 is a message 401 that is intended for posting, or a message 441 that is intended for subsequent routing to the contact-number 402′. Similarly, the database 450 and the response number provider 430 may be included directly in the controller 490. Alternatively, some or all of the functions of the controller 490 could be distributed among the modules of the system 400 in the form of custom-designed integrated circuits and the like. These and other system configuration and optimization features will be evident to one of ordinary skill in the art in view of this disclosure, and are included within the scope of the following claims.

1. A method of providing an interactive billboard, comprising facilitating:
receiving a message for posting on the billboard, with a contact-number for responding to the message, separate from the message,
associating a response-number to the contact-number,
displaying the message and the response-number on the billboard,
receiving one or more response-messages associated with the response-number, and
forwarding the one or more response-messages to the contact-number associated with the response-number.

2. The method of claim 1, further including facilitating providing a limited time duration for forwarding the response-messages to the contact-number.

3. The method of claim 2, further including facilitating
receiving an other message and an other contact-number,
associating the response-number to the other contact-number after the limited time duration, and
displaying the other message and the response-number on the billboard.

4. The method of claim 1, wherein
the one or more response-messages include at least one of:
a voice message,
a Short Messaging Service message, and
a Multimedia Messaging Service message.

5. The method of claim 1, further including facilitating receiving payment corresponding to at least one of:
displaying the message, and
forwarding the one or more response-messages.

6. The method of claim 1, further including facilitating
simultaneously displaying multiple messages on the billboard.

7. The method of claim 6, further including facilitating
associating a distinct response-number to each of the multiple messages, and
displaying each of the distinct response-numbers with each of the multiple messages.

8. The method of claim 1, wherein
the response-number is associated with multiple contact-numbers, and
the method further includes
receiving ancillary information that facilitates identification of the contact-number to which each response-message of the one or more response messages is to be forwarded.

9. The method of claim 8, wherein
the ancillary information includes at least one of:
a time of receipt of the response-message, and
an identifier associated with the message on the billboard.

10. The method of claim 1, further including
providing a further isolated communication path between a responder who provided at least one of the one or more response-messages and a poster who provided the message for posting on the billboard.

11. A billboard system comprising:
a posting receiver that is configured to receive a message, and a contact-number separate from the message,
a controller that is configured to:
associate a response-number to the message, and
display the message and the response-number on a billboard.

12. The billboard system of claim 11, further including:
a response receiver that is configured to receive a response-message associated with a received-response-number, and
a response transmitter that is configured to transmit the response-message to the contact-number that is associated with the received-response-number.

13. The billboard system of claim 12, wherein
the received-response-number is associated with multiple contact-numbers, and
the response receiver is further configured to receive ancillary information that facilitates identification of the contact-number to which the response-message is to be transmitted by the response transmitter.

14. The billboard system of claim 13, wherein
the ancillary information includes at least one of:
a time of receipt of the response-message, and
an identifier associated with the message on the billboard.

15. The billboard system of claim 12, further including
a database that is configured to store the response-number and the associated contact-number.

16. The billboard system of claim 11, wherein
the controller associates the response-number to the message for a limited time duration.

17. The billboard system of claim 11, wherein
the posting receiver is further configured to receive an other message and an other contact-number, and
the controller is further configured to:
associate the response-number to the other message, and
display the other message and the response-number on the billboard.

18. The billboard system of claim 11, wherein
the response-message includes at least one of:
a voice message,
a Short Messaging Service message, and
a Multimedia Messaging Service message.

19. The billboard system of claim 11, wherein
the controller is further configured to simultaneously display multiple messages on the billboard.

20. The billboard system of claim 19, wherein
the controller is further configured to:
associate a distinct response-number to each of the multiple messages, and
display each of the distinct response-numbers with each of the multiple messages.
